(19) United States
(12) Patent Application Publication
(10) Pub. No.: US 2017/0042172 A1
(43) Pub. Date: Feb. 16, 2017

(54) FERMENTED MILK PRODUCT

(71) Applicant: DSM IP ASSETS B.V., Heerlen (NL)

(72) Inventors: Cornelia Elizabeth Paulina MALJAARS, Echt (NL); Filip Stefan Emiel OOSTERLINCK, Echt (NL); Claire Emiel OOSTERLINCK, Echt (NL)

(21) Appl. No.: 15/305,577

(22) PCT Filed: Apr. 22, 2015
(86) PCT No.: PCT/EP2015/058671

§ 371 Date: Oct. 20, 2016

(30) Foreign Application Priority Data
Apr. 23, 2014 (EP) 14165668.6

(51) Int. Cl. A23C 9/123

(52) U.S. Cl. CPC A23C 9/1238; A23Y 2220/15; A23Y 2220/29; A23Y 2240/75

(57) ABSTRACT

The present invention relates to a fermented milk product with improved gel strength and/or serum viscosity.

### FIELD OF THE INVENTION

The present invention relates to a composition comprising lactic acid bacteria and a process for manufacturing fermented dairy products using said composition.

### BACKGROUND OF THE INVENTION

The food industry uses different bacteria, in the form in particular of ferments, in particular lactic acid bacteria, in order to improve the taste and the texture of foods but also to extend the shelf life of these foods. In the case of the dairy industry, lactic acid bacteria are used intensively in order to bring about the acidification of milk (by fermentation) but also in order to texturize the product into which they are incorporated. Among the lactic acid bacteria used in the food industry, there can be mentioned the genera Streptococcus and Lactobacillus. The lactic acid bacterial species Streptococcus thermophilus and Lactobacillus delbrueckii ssp bulgaricus are used in particular in the formulation of the ferments used for the production of fermented milks, for example yogurts.

The acidity produced in yogurt depends mainly on the acidifying activity of the yogurt culture (Streptococcus thermophilus and Lactobacillus delbrueckii ssp. bulgaricus) and therefore the amount of lactic acid produced during the milk maturation and also the residual acidity produced during cold storage. The texture is also varying during storage and participates in the final product sensorial properties. The recipe of the yogurt has also an impact on the yogurt sensorial properties by modifying the texture or the aroma perception.

Fermented milk products such as yogurts, are often fortified with extra protein in order to increase the thickness of the products. Proteins mostly used for this purpose are milk protein sources such as caseinates, whey protein isolates and skim milk powder. Protein prices are increasing because of increasing demand. This is also true for milk proteins. Fortification of fermented milk products with milk proteins is thus becoming more expensive. As a result dairy companies are looking for opportunities to reduce the milk protein content that is used for fortification of the fermented milk products.

Reduction of milk protein content in fermented milk products comes at a cost. Milk proteins are key in generating a certain protein gel strength within the dairy product. Reduction of the protein content thus leads to reduction of the gel strength, and as a result the thickness of the yogurt in sensory perception is reduced. This is undesirable and puts a strong restriction on the extent with which the protein content can be reduced in fermented milk products. The solution for reduction of the protein content is to find a means to compensate for the loss in gel strength. There are several methods known to the person skilled in the art, such as introduction of texturizing agents. Texturizing agents, such as stabilizers and gelatine can be used to reduce the amount of milk protein added. While the use of texturizing agents, such as stabilizers, in yogurt can be more cost effective than milk protein addition, their use is restricted by regulation and labeling laws. For example, in Canada texturizing agents may not be added to more than 2% w/w of the final product. Also, in the EU hydrocolloids are assigned an “E number” which may be unappealing to the consumer. In addition, enzymatic treatment, such as transglutaminase [Lauber et al., 2000; Chr Lorenzen et al., 2002] or heat treatment regimens [Lauber et al., 2001] may be applied to compensate for the loss in gel strength.

The inventors have now surprisingly found a new method to compensate for the loss in gel strength by using a starter culture composition. The cultures of the invention have the ability to increase the gel strength and/or the serum viscosity thereby improving the texture of a fermented milk product with reduced protein to compensate (partly) for the loss in thickness and creaminess of the fermented milk product.

### Definitions

The term “milk” is intended to encompass milks from mammals and plant sources or mixtures thereof. Preferably, the milk is from a mammal source. Mammal sources of milk include, but are not limited to cow, sheep, goat, buffalo, camel, llama, mare and deer. In an embodiment, the milk is from a mammal selected from the group consisting of cow, sheep, goat, buffalo, camel, llama, mare and deer, and combinations thereof. Plant sources of milk include, but are not limited to, milk extracted from soy bean, pea, peanut, barley, rice, oat, quinoa, almond, cashew, coconut, hazelnut, hemp, sesame seed and sunflower seed. In addition, the term “milk” refers to not only whole milk, but also skim milk or any liquid component derived thereof.

As used in the present specification, the term “fermented milk product” refers to a product that has been fermented with lactic acid bacteria such as Streptococcus thermophilus and optionally Lactobacillus delbruekii subsp. bulgaricus, but also, optionally, other microorganisms such as Lactobacillus delbruekii subsp. lactis, Bifidobacterium animalis subsp. lactis, Lactococcus lactis, Lactobacillus acidophilus and Lactobacillus casei, or any microorganism derived therefrom. The lactic acid strains other than Streptococcus thermophilus and Lactobacillus delbruekii subsp. bulgaricus, are intended to give the finished product various properties, such as the property of promoting the equilibrium of the flora. The fermentation process increases the shelf-life of the product while enhancing and improving the digestibility of milk. Many different types of fermented milk products can be found in the world today. Examples are soured milk (e.g. buttermilk), soured cream and yogurt.

As used herein, the term “yogurt” is a fermented milk product produced by fermentation of milk by lactic acid bacteria, also known as “yogurt cultures”. The fermentation of the lactose in the milk produces lactic acid which acts on the milk protein to give the yogurt its texture. Yogurt may be made from cow milk, the protein of which mainly comprises casein, which is most commonly used to make yogurt, but milk from sheep, goat, buffalo, camel, llama, mare, deer, water buffalo, ewes and/or mares, and combinations thereof may be used as well. The term “yogurt” furthermore encompasses, but is not limited to, yogurt as defined according to French and European regulations, e.g. coagulated dairy products obtained by lactic acid fermentation by means of specific thermophilic lactic acid bacteria only (i.e. Lactobacillus delbruekii subsp. bulgaricus and Streptococcus thermophilus) which are cultured simultaneously and are found to be living in the final product in an amount of at least 10 million CFU (colony-forming unit) per gram of the yogurt. Preferably, the yogurt is not heat-treated after fermentation. Yogurts may optionally contain added dairy raw materials (e.g. cream and/or protein) or other ingredients such as sugar or sweetening agents, one or more flavouring(s), cereals or nutritional substances, especially vitamins, minerals and fibers. Such yogurt advantageously meets the specifications for fermented milks and yogurts of the AFNOR NF 04-600 standard and/or the codex StanA-IIa-1975 standard. In order to satisfy the AFNOR NF 04-600 standard, the product must not have been heated after fermentation and the dairy raw materials must represent a minimum of 70 wt % of the finished product. Yogurt encompasses set yogurt, stirred yogurt, drinking yogurt, Petit Suisse, heat treated yogurt and yogurt-like products. Preferably, the yogurt is a stirred yogurt or a drinking yogurt. More preferably, the yogurt is a stirred yogurt.

The term “starter culture composition” or “composition” (also referred to as “starter” or “starter culture”) as used herein refers to a composition comprising one or more lactic acid bacteria, which are responsible for the acidification of the milk base. Starter cultures compositions may be fresh (liquid), frozen or freeze-dried. Freeze dried cultures need to be regenerated before use. For the production of a fermented dairy product, the starter cultures composition is usually added in an amount from 0.01 to 3%, preferably from 0.01 and 0.02% by weight of the total amount of milk base.

As used herein, the term “lactic acid bacteria” (LAB) or “lactic bacteria” refers to food-grade bacteria producing lactic acid as the major metabolic end-product of carbohydrate fermentation. These bacteria are related by their common metabolic and physiological characteristics and are usually Gram positive, low-GC, acid tolerant, non-sporulating, non-respiring, rod-shaped bacilli or cocci. During the fermentation stage, the consumption of lactose by these bacteria causes the formation of lactic acid, reduces the pH and leads to the formation of a (milk) protein coagulum. These bacteria are thus responsible for the acidification of milk and for the texture of the fermented milk product.

As used herein, the term “lactic acid bacteria” or “lactic bacteria” encompasses, but is not limited to, bacteria belonging to the genus of Lactobacillus spp., Bifidobacterium spp., Streptococcus spp., Lactococcus spp., such as Lactobacillus delbruekii subsp. bulgaricus, Streptococcus thermophilus, Lactobacillus lactis, Bifidobacterium animalis, Lactococcus lactis, Lactobacillus casei, Lactobacillus plantarum, Lactobacillus helveticus, Lactobacillus acidophilus and Bifidobacterium breve.

The term “improvement” or “improved” as used in improvement of one or more of the attributes related to texture as defined herein below, means an improvement of one or more of the attributes related to texture obtained while using the composition of the invention as defined herein below in comparison with a composition comprising lactic acid bacteria other than at least strain B or at least strain D, or at least the combination of strain B and strain D. In the Examples such a composition has been used as the Reference. A control experiment without lactic acid bacteria is of course meaningless since in that case no fermented milk product such as yogurt can be obtained and no comparison can be made. An improvement in one or more of the attributes related to texture may be measured absolutely for instance in the case of Brookfield (Pa*s units) or shear stress (Pa units) or more relatively by a taste panel for instance for all the sensory aspects of the fermented milk product.

### DETAILED DESCRIPTION OF THE INVENTION

In a first aspect the invention provides a process for the production of a fermented milk product, preferably yogurt, comprising fermenting milk using a composition comprising one or more bacterial strains selected from the group consisting of Streptococcus thermophilus DS71579 (Strain A), Streptococcus thermophilus DS71586 (Strain B), Streptococcus thermophilus DS71584 (Strain C), and Streptococcus thermophilus DS71585 (Strain D) and wherein the gel strength and/or the serum viscosity of the fermented milk product obtained, preferably yogurt, has been improved compared to the gel strength of a fermented milk product that has not been produced using the composition comprising one or more bacterial strains selected from the group consisting of Streptococcus thermophilus D571579 (Strain A), Streptococcus thermophilus DS71586 (Strain B), Streptococcus thermophilus DS71584 (Strain C), Streptococcus thermophilus DS71585 (Strain D). One preferred embodiment of the process of the invention is using a composition comprising at least strain A. Another preferred embodiment of the process of the invention is using a composition comprising at least strain B. Another preferred embodiment of the process of the invention is using a composition comprising at least strain C. Another preferred embodiment of the process of the invention is using a composition comprising at least strain D.

The advantage of the process of the invention is that strain A as well as strain B as well as strain C as well as strain D is capable of improving the gel strength and/or the serum viscosity of a fermented milk product such as yogurt. Strain A as well as strain B as well as strain C as well as strain D used in the process of the invention is not only capable of improving the gel strength and/or the serum viscosity of the fermented milk products such as yogurt as such, but in particular strain A as well as strain B as well as strain C as well as strain D, as well as the below compositions 1 to 37, are capable of partially or fully restoring the gel strength and/or the serum viscosity of the fermented milk product such as yogurt wherein the protein content has been reduced, to the gel strength and/or the serum viscosity of the fermented milk product such as yogurt wherein the protein content not has been reduced. Therefore, instead of adding additional protein in the process of the invention for the production of a fermented milk protein such as yogurt with an improved gel strength and/or the serum viscosity, a composition comprising the lactic acid bacteria strain A or strain B or strain C or strain D as defined herein before may be used in the process of the invention in order to obtain an improved gel strength and/or serum viscosity.

Another advantage of the present invention is that the present strains provide an improved acidification rate, i.e. the time to reach pH 4.6. A reduced time to reach pH 4.6 is advantageous for large scale production of yogurt wherein it is beneficial to reduce manufacturing time of the yogurt. In a preferred embodiment, the present composition comprising one or more bacterial strains provides a time to reach pH 4.6 of less than 400 minutes, preferably less than 380 minutes, more preferably less than 360 minutes for yogurts having a protein content of smaller than 4.0%. In another preferred embodiment, the present composition comprising one or more bacterial strains provides a time to reach pH 4.6 of less than 500 minutes, preferably less than 450 minutes, more preferably less than 420 minutes, most preferably less than 400 minutes for yogurts having a protein content of more than 4.0%.

Preferred compositions to be used in the process of the invention are the following.

Compositions comprising at least 1 strain from the group consisting of strain A and strain B and strain C and strain D.
1. Composition comprising at least Streptococcus thermophilus strain A.
2. Composition comprising at least Streptococcus thermophilus strain A and a Lactobacillus delbrueckii ssp. bulgaricus preferably strain E.
3. Composition comprising at least Streptococcus thermophilus strain B.
4. Composition comprising at least Streptococcus thermophilus strain B and a Lactobacillus delbrueckii ssp. bulgaricus preferably strain E.
5. Composition comprising at least Streptococcus thermophilus strain C.
6. Composition comprising at least Streptococcus thermophilus strain C and a Lactobacillus delbrueckii ssp. bulgaricus preferably strain E.
7. Composition comprising at least Streptococcus thermophilus strain D.
8. Composition comprising at least Streptococcus thermophilus strain D and a Lactobacillus delbrueckii ssp. bulgaricus preferably strain E.

Compositions comprising at least 2 strains from the group consisting of strain A and strain B and strain C and strain D.
9. Composition comprising at least Streptococcus thermophilus strain A and strain B
10. Composition comprising at least Streptococcus thermophilus strain A and strain B and a Lactobacillus delbrueckii ssp. bulgaricus preferably strain E.
11. Composition comprising at least Streptococcus thermophilus strain A and strain C
12. Composition comprising at least Streptococcus thermophilus strain A and strain C and a Lactobacillus delbrueckii ssp. bulgaricus preferably strain E.
13. Composition comprising at least Streptococcus thermophilus strain A and strain D.
14. Composition comprising at least Streptococcus thermophilus strain A and strain D and a Lactobacillus delbrueckii ssp. bulgaricus preferably strain E.
15. Composition comprising at least Streptococcus thermophilus strain B and strain C
16. Composition comprising at least Streptococcus thermophilus strain B and strain C and a Lactobacillus delbrueckii ssp. bulgaricus preferably strain E.
17. Composition comprising at least Streptococcus thermophilus strain B and strain D.
18. Composition comprising at least Streptococcus thermophilus strain B and strain D and a Lactobacillus delbrueckii ssp. bulgaricus preferably strain E.
19. Composition comprising at least Streptococcus thermophilus strain C and strain D
20. Composition comprising at least Streptococcus thermophilus strain C and strain D and a Lactobacillus delbrueckii ssp. bulgaricus preferably strain E.

Compositions comprising at least 3 strains from the group consisting of strain A and strain B and strain C and strain D.
21. Composition comprising at least Streptococcus thermophilus strain A and strain B and strain C.
22. Composition comprising at least Streptococcus thermophilus strain A and strain B and strain C and a Lactobacillus delbrueckii ssp. bulgaricus preferably strain E.
23. Composition comprising at least Streptococcus thermophilus strain A and strain B and strain D.
24. Composition comprising at least Streptococcus thermophilus strain A and strain B and strain D and a Lactobacillus delbrueckii ssp. bulgaricus preferably strain E.
25. Composition comprising at least Streptococcus thermophilus strain B and strain C and strain D.
26. Composition comprising at least Streptococcus thermophilus strain B and strain C and strain D and a Lactobacillus delbrueckii ssp. bulgaricus preferably strain E.
27. Composition comprising at least Streptococcus thermophilus strain A and strain C and strain D.
28. Composition comprising at least Streptococcus thermophilus strain A and strain C and strain D and a Lactobacillus delbrueckii ssp. bulgaricus preferably strain E.

Compositions comprising at least 4 strains from the group consisting of strain A and strain B and strain C and strain D.
29. Composition comprising at least Streptococcus thermophilus strain A and strain B and strain C and strain D.
30. Composition comprising at least Streptococcus thermophilus strain A and strain B and strain C and strain D and a Lactobacillus delbrueckii ssp. bulgaricus preferably strain E.
31. Composition ABCDE as defined in Table 2.
32. Composition AE as defined in Table 2.
33. Composition BE as defined in Table 2.
34. Composition CE as defined in Table 2.
35. Composition DE as defined in Table 2.
36. Composition BDE as defined in Table 2.
37. Composition BD as defined in Table 2.

Each of the 37 compositions listed above may encompass different embodiments depending on the amount of the strains present in the composition. The individual strains in the compositions may constitute any suitable percentage of the total cfu's (colony forming units) in the compositions. In the composition comprising only one of the strains A, B, C and D, these strains may constitute 100% of the cfu's.

Each of the 37 compositions may however, comprise further other lactic acid bacterial strains. In those compositions, the total cfu's relates not only to the strains A and/or B and/or C and/or D and/or E present in the composition but also to the other bacterial strains present in the compositions. The composition may further comprise other lactic acid bacterial strains as defined hereinbefore such as one or more lactic acid bacterial strains selected from the group consisting of Lactobacillus spp., Bifidobacterium spp., Streptococcus spp., Lactococcus spp., such as Lactobacillus delbruekii subsp. bulgaricus, Streptococcus salivarius thermophilus or Streptococcus thermophilus, Lactobacillus lactis, Bifidobacterium animalis, Lactococcus lactis, Lactobacillus casei, Lactobacillus plantarum, Lactobacillus helveticus, Lactobacillus acidophilus and Bifidobacterium breve. Preferably the composition used in the process of the invention may further comprise one or more other Streptococcus thermophilus strains or one or more other Lactobacillus delbrueckii ssp. bulgaricus strains. These strains may be added because they may have other properties that are advantageous in for instance a process for the production of a fermented milk product such as yogurt or in the final properties of the fermented milk product such as yogurt. These strains may for instance further improve the acidification speed or they may confer certain flavours such as in the case of adjunct cultures.

Lactobacillus delbrueckii ssp. bulgaricus strain is a classical yogurt strain and may be present in the composition to be used in the process of the invention. The inventors have found, however, that the Lactobacillus delbrueckii ssp. bulgaricus strain did not contribute to (the improvements of) any of the texture attributes. Yogurts made with a composition that is lacking a Lactobacillus delbrueckii ssp. bulgaricus gave the same values of the texture attributes compared to the same composition comprising a Lactobacillus delbrueckii ssp. Bulgaricus, such as strain E.

Lactobacillus delbrueckii ssp. bulgaricus, when present in the compositions of the invention, preferably strain E (Lactobacillus delbrueckii ssp. bulgaricus DS71836) may constitute between 0.1% and 10% of the total cfu's of the composition, preferably between 0.2% and 5%, more preferably between 0.5% and 2%, more preferably between 0.8 and 1.2%, most preferably 1%. Strain E in the compositions used in the process of the invention (Lactobacillus delbrueckii ssp. bulgaricus DS71836) comprising 2 or more strains of which at least one strain is strain E, constitutes between 0.1% and 10% of the total cfu's of the composition, preferably between 0.2% and 5%, more preferably between 0.5% and 2%, more preferably between 0.8 and 1.2%, most preferably 1%. Preferably, the Streptococcus thermophilus strains A, B, C and D constitute the remaining cfu's of the composition of the invention.

In the compositions comprising one Streptococcus thermophilus strain (A or B or C or D) and strain E, strain E may be present as described above, i.e. between 0.1% and 10% of the total cfu's of the composition, preferably between 0.2% and 5%, more preferably between 0.5% and 2%, more preferably between 0.8 and 1.2%, most preferably 1%. In those compositions, the Streptococcus thermophilus strain constitutes the remaining cfu's whereby the total cfu's is 100%.

The strains in the compositions comprising two or three or four of the Streptococcus thermophilus strains A, B, C and D may constitute the individual Streptococcus thermophilus strains in any suitable percentage of the total Streptococcus thermophilus cfu's in the composition. In the compositions comprising two or more of the Streptococcus thermophilus strains and strain E, strain E is present as described above, i.e. between 0.1% and 10% of the total cfu's of the composition, preferably between 0.2% and 5%, more preferably between 0.5% and 2%, more preferably between 0.8 and 1.2%, most preferably 1%. In those compositions, the Streptococcus thermophilus strains constitute the remaining cfu's whereby the total cfu's is 100%.

The most preferred fermented milk product that is produced by the process of the second aspect of the invention is yogurt as defined hereinbefore. The milk that may be used in the process of the third aspect of the invention, may be any milk suitable for the production of a fermented milk product, such as yogurt. Milk has been defined hereinbefore and may encompass milks from mammals and plant sources or mixtures thereof. Preferably, the milk is from a mammal source. Mammal sources of milk include, but are not limited to cow, sheep, goat, buffalo, camel, llama, mare and deer. In an embodiment, the milk is from a mammal selected from the group consisting of cow, sheep, goat, buffalo, camel, llama, mare and deer, and combinations thereof. Plant sources of milk include, but are not limited to, milk extracted from soy bean, pea, peanut, barley, rice, oat, quinoa, almond, cashew, coconut, hazelnut, hemp, sesame seed and sunflower seed. In addition, the term “milk” refers to not only whole milk, but also skim milk or any liquid component derived thereof. The fat content in the milk and in the subsequent fermented milk product, such as yogurt, may be as is known in the prior and as is referred in the background of the invention.

In one preferred embodiment, the invention provides a process for the production of a fermented milk product, preferably yogurt, wherein the gel strength is improved. In another preferred embodiment, the invention provides a process for the production of a fermented milk product, preferably yogurt, wherein the serum viscosity is improved. Most preferred is an embodiment, wherein the invention provides a process for the production of a fermented milk product, preferably yogurt, wherein both the gel strength and the serum viscosity is improved.

In a further preferred embodiment, the invention provides a process for the production of a fermented milk product, preferably yogurt, wherein the protein level is reduced. More preferably the invention provides a process for the production of a fermented milk product, preferably yogurt, wherein the protein level is reduced while the the gel strength and/or the serum viscosity is maintained. More preferably the present invention provides a process for the production of a fermented milk product, preferably yogurt, wherein the protein level is less than 12%, less than 11%, less than 10%, less than 9.5%, less than 9.0%, less than 8.5%, less than 8.0%, less than 7.5%, less than 7.0%, less than 6.5%, less than 6.0%, less than 5.5%, less than 5.0%, less than 4.9%, less than 4.8%, less than 4.7%, less than 4.6%, less than 4.5%, less than 4.4%, less than 4.3%, less than 4.2%, less than 4.1%, less than 4.0%, less than 3.9%, less than 3.8%, less than 3.7%, less than 3.6%, less than 3.5%, less than 3.4%, less than 3.3%, less than 3.2%, less than 3.1% or less than 3.0% of the fermented milk product, preferably yogurt.

In a second aspect, the invention provides a fermented milk product, preferably yogurt, obtainable by the process of the first aspect of the invention and comprising one of the compositions as defined hereinbefore, preferably composition 1 or composition 2 or composition 3 or composition 4 or composition 5 or composition 6 or composition 7 or composition 8 or composition 9 or composition 10 or composition 11 or composition 12 or composition 13 or composition 14 or composition 15 or composition 16 or composition 17 or composition 18 or composition 19 or composition 20 or composition 21 or composition 22 or composition 23 or composition 24 or composition 25 or composition 26 or composition 27 or composition 28 or composition 29 or composition 30 or composition 31 or composition 32 or composition 33 or composition 34 or composition 35 or composition 36 or composition 37 characterized in that the fermented milk product, preferably yogurt, has an improved gel strength and/or an improved serum viscosity compared to a fermented milk product, preferably yogurt, that has not been produced by the process of the first aspect of the invention and/or does not comprise one of the compositions as defined hereinbefore.

In a preferred embodiment, the fermented milk product, preferably yogurt, obtainable by the process of the first aspect of the invention comprises less than 12%, less than 11%, less than 10%, less than 9.5%, less than 9.0%, less than 8.5%, less than 8.0%, less than 7.5%, less than 7.0%, less than 6.5%, less than 6.0%, less than 5.5%, less than 5.0%, less than 4.9%, less than 4.8%, less than 4.7%, less than 4.6%, less than 4.5%, less than 4.4%, less than 4.3%, less than 4.2%, less than 4.1%, less than 4.0%, less than 3.9%, less than 3.8%, less than 3.7%, less than 3.6%, less than 3.5%, less than 3.4%, less than 3.3%, less than 3.2%, less than 3.1% or less than 3.0% protein content.

In a further preferred embodiment, the present fermented milk product, preferably yogurt, obtainable by the process of the first aspect of the invention comprises a reduced protein content if compared with a fermented milk product, preferably yogurt that has not been produced by the process of the first aspect of the invention and/or does not comprise one of the compositions as defined hereinbefore. Preferably the reduced protein content is a reduction of at least 5%, preferably at least 10%, more preferably at least 15%, most preferably at least 20%.

It is found by the present inventors that the above protein contents, or reduced protein content, is combined with a gel strength and/or serum viscosity which is maintained, or not reduced, if compared with a fermented milk product, preferably yogurt, wherein the protein content, or reduced protein content, has not been reduced.

In a third aspect, the invention provides the use of any of one of the compositions as defined hereinbefore, preferably composition 1 or composition 2 or composition 3 or composition 4 or composition 5 or composition 6 or composition 7 or composition 8 or composition 9 or composition 10 or composition 11 or composition 12 or composition 13 or composition 14 or composition 15 or composition 16 or composition 17 or composition 18 or composition 19 or composition 20 or composition 21 or composition 22 or composition 23 or composition 24 or composition 25 or composition 26 or composition 27 or composition 28 or composition 29 or composition 30 or composition 31 or composition 32 or composition 33 or composition 34 or composition 35 or composition 36 or composition 37 for the production of the fermented milk product, preferably yogurt as defined in any of claims 22, having an improved gel strength and/or an improved serum viscosity compared to a fermented milk product, preferably yogurt, that has not been produced by such a composition.

In a preferred embodiment, the present invention relates to the use of any of the compositions 1 to 37, such as composition 17 or 24, for the production of a fermented milk product, preferably yogurt, wherein the time to reach pH 4.6 is reduced compared to a fermented milk product, preferably yogurt, that has not been produced by any of the composition 1 to 37 such as composition 17 or 24.

In a further preferred embodiment, the present invention relates to the use of any of the compositions 1 to 37, such as composition 17 or 24, for the production of a fermented milk product, preferably yogurt, having a reduced protein content compared to a fermented milk product, preferably yogurt, that has not been produced by any of the composition 1 to 37 such as composition 17 or 24. Preferably the reduced protein content is a reduction of at least 5%, preferably at least 10%, more preferably at least 15%, most preferably at least 20% if compared with a fermented milk product, preferably yogurt, that has not been produced by any of the composition 1 to 37 such as composition 17 or 24.

### FIGURES

FIG. 1 is a graph showing the shear stress at a shear rate of 215 s-1 for four different lactic acid blends in yogurt of three different protein levels.

FIG. 2 is a graph showing the shear stress for four different lactic acid blends over the shear rate of 10 to 1000 s-1 in a yogurt with 3.4% protein.

FIG. 3 is a graph showing the shear stress for four different lactic acid blends over the shear rate of 10 to 1000 s-1 in a yogurt with 3.8% protein.

FIG. 4 is a graph showing the shear stress for four different lactic acid blends over the shear rate of 10 to 1000 s-1 in a yogurt with 4.2% protein.

FIG. 5 is an overview of stirring the yogurt before measuring the shear stress.

### MATERIALS AND METHODS

### 1. Bacterial Strains.

TABLE 1
Bacterial strains

| Strain | CBS number | Strain |
|---|---|---|
| A | CBS134831 | Streptococcus thermophilus DS71579 |
| B | CBS134834 | Streptococcus thermophilus DS71586 |
| C | CBS134832 | Streptococcus thermophilus DS71584 |
| D | CBS134833 | Streptococcus thermophilus DS71585 |
| E | CBS134835 | Lactobacillus delbrueckii ssp. bulgaricus DS71836 |

All strains A-E were deposited on 9 Apr. 2013 at the Centraalbureau voor Schimmelcultures (Fungal Biodiversity Centre), Uppsalalaan 8, 3584 CT Utrecht, The Netherlands under the provisions of the Budapest Treaty.

### 2. Compositions Comprising Bacterial Strains

The following compositions were used in the Examples. The percentages relate to the cfu's (colony forming units)—see Table 2.

TABLE 2
Compositions comprising bacterial strains - the % values relate to the
cfu's of the respective strain in the composition.

| Composition | Strain A | Strain B | Strain C | Strain D | Strain E |
|---|---|---|---|---|---|
| ABCDE | 24.75% | 24.75% | 24.75% | 24.75% | 1% |
| AE | 99.0% | — | — | — | 1% |
| BE | — | 99.0% | — | — | 1% |
| CE | — | — | 99.0% | — | 1% |
| DE | — | — | — | 99.0% | 1% |
| BDE | — | 49.5% | — | 49.5% | 1% |
| BD | | 50% | | 50% | |

The Reference culture (Ref) used in the examples is a commercially available yogurt starter culture and does not contain any of strains A-E.

### 3. Yogurt Preparation (All Examples)

The fermented milk used is obtained by supplementing pasteurized skimmed milk (Campina, The Netherlands) with skimmed milk powder and cream (containing 39% fat). The final recipe is described in the different examples. The milk mixture is pasteurized at 92° C. for 6 minutes. In line homogenization takes place in the heating part of the pasteurizer at 60° C., in two stages of 80 and 40 bar. The homogenized, pasteurized milk is cooled back to the fermentation temperature (38° C.) and inoculated with the culture to be tested at a rate of 0.02% (w/w) Once a pH of 4.60 is reached, the yogurt is smoothened by pumping the yogurt through a sieve (poresize 500 μm). The yogurt is then filled out into suitable containers. The yogurt cups are then stored at 4° C.

### 4. Yogurt Recipes

The following recipes were used in the Examples. All additions are wt % of the total milk recipe.

TABLE 3
Yogurt recipes

| | Recipe | | | | | | |
|---|---|---|---|---|---|---|---|
| Ingredient (%) | A | B | C | D | E | F | G |
| Skimmed Milk | 96.0 | 81.6 | 82.2 | 87.7 | 0 | 0 | 0 |
| Semi skimmed Milk | 0 | 0 | 0 | 0 | 91.4 | 90.1 | 88.7 |
| Skimmed Milk | 0.4 | 0.0 | 6.3 | 1.0 | 0.9 | 2.2 | 3.6 |
| Powder | | | | | | | |
| Cream (39% fat) | 3.6 | 3.8 | 3.8 | 3.6 | 0 | 0 | 0 |
| Sucrose | 0.0 | 7.7 | 7.7 | 7.7 | 7.7 | 7.7 | 7.7 |
| Demineralized water | 0.0 | 6.9 | 0.0 | 0.0 | 0 | 0 | 0 |
| Fat concentration | 1.4 | 1.5 | 1.5 | 1.4 | 1.4 | 1.4 | 1.4 |
| Protein | 3.5 | 2.9 | 5.1 | 3.5 | 3.4 | 3.8 | 4.2 |
| concentration | | | | | | | |

### 5. Shear Stress of Yogurt

The samples were measured using a Physica MCR501 rheometer equipped with a concentric cylinder measurement system (CC-27). A solvent trap was used to prevent evaporation of water as much as possible. Yogurt samples are stored at 4° C. and are taken out of storage just prior to measuring in the rheometer, with the containers having to be handled with extreme care (as any sudden movements might damage the yogurt microstructure and thus lead to differences in results). As shown in FIG. 5, the closed container is turned from an upright position to a tilted one with an angle of 100°, so that the container lid is now the lowest point. At this point, one has to turn the container 3 times around its axis (3×360°, ˜4 seconds per revolution), to slightly stir the yogurt without really damaging its structure. Subsequently the container is turned back into a normal upright position and can be opened. Once opened, one has to ascertain that there is no dried in material at the top of the container: if that is the case, this dried in material needs to be removed on one side (the side along which the yogurt will be poured). The container can then be slightly turned again to its side till the yogurt level reaches the top of the container at which time the yogurt can be gently spooned out of and over the top of the container into the measuring cup. Once filled the measuring cup is placed into the Physica Rheometer and superfluous material is removed by using a pipette. The procedure to load the yogurts takes about two minutes. Care needs to be taken to treat all different samples in exactly the same way, since difference in loading conditions can cause differences in the relative ranking of the yogurts. Before measurement the samples were allowed to rest and heat/cool to the measuring temperature (25° C.) for 5 minutes.

A standard experimental protocol was applied consisting out of the following two measuring sequences:
1. A strain sweep to determine the initial gel strength (dynamic shear modulus): this is an oscillatory test where at a fixed angular frequency (omega=10 rad/s) an increasing amplitude is applied: on a logarithmic scale the amplitude is increased from 0.01 to 100% with 5 measuring points per decade.
2. After the strain sweep the yogurts are allowed to rest for 30 seconds in the rheometer and subsequently a shear rate sweep is applied to determine the shear stress in mouth: This consists of applying an increasing shear rate to the yogurts ranging from 0.001 to 1000 s-1 on a logarithmic scale with 3 measuring points per decade (no fixed time setting: the rheometer software determines the required shearing time per measuring point).
   This experiment gives a flow curve whereby the measured stress is plotted as a function of the applied shear rate. This curve can then be combined with literature data to determine the relevant shear stress in the mouth as explained in the following.

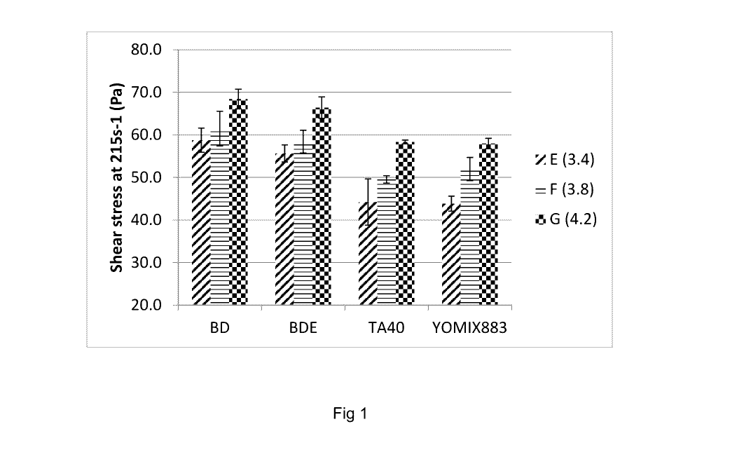

By sensory panelling of various food products Shama and Sherman identified windows of instrumental shear stresses and shear rates corresponding to products with similar thickness ratings but different shear-thinning behavior. These windows correspond to the rheological regimes applied in the mouth during thickness rating. The governing shear rate was shown to be dependent on the viscosity of the product itself. (see FIG. 1 from Shama, F. and Sherman, P. Journal of Texture Studies, 4, 111-118. (1973), “Identification of stimuli controlling the sensory evaluation of viscosity II oral methods”).

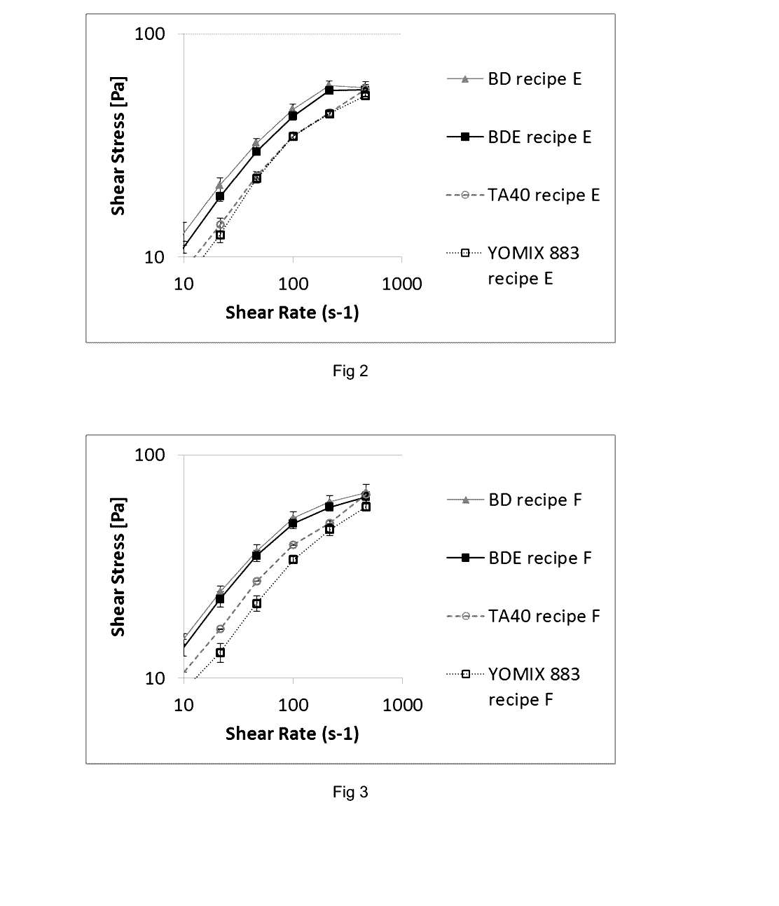

For the yogurts of the examples below the (predicted) shear stress in the mouth is determined by plotting the experimentally measured flow curves (measured shear stress in function of applied shear rate of the shear rate sweep experiment described above) onto the aforementioned FIG. 1 from Shama and Sherman. The predicted shear stress in the mouth is defined as the cross-over between the measured flow curves and the upper bound of the “shear rate shear stress” windows of FIG. 1 of Shama and Sherman. In FIG. 2 the authors give examples for various food stuffs. The thus derived shear stress gave a good correlation with the sensory perception of thickness in the mouth.

### 6. Brookfield

Viscosity measurement were performed using a Brookfield RVDVII+ Viscometer, which allows viscosity measurement on an undisturbed product (directly in the pot). The Brookfield Viscometer determines viscosity by measuring the force required to turn the spindle into the product at a given rate. The Helipath system with a T-C spindle was used as it is designed for non-flowing thixotropic material (gels, cream). It slowly lowers or raises a rotating T-bar spindle into the sample so that not always the same region of the sample is sheared (helical path). Thus, the viscometer measures constantly the viscosity in fresh material, and is thus thought to be the most suitable for measuring stirred yogurt viscosity. A speed of 30 rpm was used for 31 measuring points, at an interval of 3 sec. The average of the values between 60 and 90 seconds are reported.

### 7. Serum Viscosity

A yogurt can be seen as a two-phase system: a protein rich phase embedded into a water-rich serum phase. The viscosity of such a system will be determined by the collective contribution of the two phases. In order to determine the contribution of the serum phase, the latter has been isolated by centrifugation of tubes filled with 40 g yogurt each in a BHG Hermle Z320 centrifuge (1 h at 4000 RPM/2500 g). The clear serum phase is decanted. This serum viscosity is measured using a Physica MCR 300 Rheometer. After loading, a shear rate sweep is applied to the samples: This consists of applying an increasing shear rate to the yogurts ranging from 40 s⁻¹ to 1000 s⁻¹ on a logarithmic scale with 5 measuring points per decade. The serum viscosity is defined as the measured viscosity at 100 s⁻¹.

### 8. Gel Strength

The samples were measured using a Physica MCR501 rheometer equipped with a concentric cylinder measurement system (CC-27). A solvent trap was used to prevent evaporation of water as much as possible. The samples were slightly stirred with a spoon before loading into the rheometer. Before measuring, the samples were allowed to rest and brought to the measuring temperature (25° C.) and maintained at that temperature for 5 minutes. In order to determine the gel strength (i.e. the dynamic shear modulus G (Pa)), a strain sweep is applied to the sample: this is an oscillatory test where at a fixed angular frequency (omega=10 rad/s) an increasing amplitude is applied: on a logarithmic scale the amplitude is increased from 0.01 to 100% with 5 measuring points per decade. The gel strength of a material is defined as the average of the measured moduli between the strain of 0.01% to 0.25% (so in the linear regime).

### 9. Sensory Analysis

In a sensory analysis the attributes thickness of mouth feel and ropiness are analysed. Thickness of mouth feel is the degree in which the product feels thick in the mouth. This sensation can be best perceived between tongue and palate. Ropiness is the degree in which the yogurt runs from the spoon.

The method used to perform the sensory analysis for the ropy structure and thickness in mouth feel was a ranking test. The panelists received the four products simultaneously in random order. The assessors were asked to rank the samples according to the specified attribute from least to most. The two attributes were assessed separately using new three digit codes to avoid any bias. The results were obtained by using the software FIZZ acquisition (Biosystemes, France, Couternon). Hereafter the results were computed by using the Friedman test (analysis of variance by ranks). As four products per recipe have to be measured, three sessions were held, resulting in 22 observations per measurement. The sum of ranks is calculated by measuring the total allocated 1, 2, 3 or 4 points, wherein 1 point is allocated for the lowest rank and 4 points for the highest rank.

### EXAMPLES

### Example 1

### Effect of Lactic Acid Bacterial Strains on the Gel Strength and the Serum Viscosity of a Yogurt

Yogurt was made according to recipe A as defined in Table 3 and according to the method described in the Materials and Methods.

TABLE 4

| | Composition (see Table 3) | | | | |
|---|---|---|---|---|---|
| Attribute | Reference | ABCDE | BE | DE | BDE |
| Time to reach | 470 | 445 | 445 | 515 | 479 |
| pH = 4.6 (min) | | | | | |
| Brookfield (Pa * s) | 6 | 7 | 9 | 7 | 10 |
| Shear stress (Pa) | 17 | 21 | 23 | 17 | 27 |
| Gel strength | 58 | 70 | 64 | 75 | 80 |
| dynamic modulus | | | | | |
| G* (Pa) | | | | | |
| Serum viscosity | 1.42 | 1.46 | 1.58 | 1.48 | 1.62 |
| (mPa * s) | | | | | |

The results show that all compositions BE, DE, BDE and ABCDE improve the gel strength and serum viscosity compared to the Reference composition.

### Example 2

### Effect of Lactic Acid Bacterial Strains on the Gel Strength of a Yogurt

Yogurt was made according to recipe D as defined in Table 3 and according to the method described in the Materials and Methods.

TABLE 5

| | Composition (see Table 3) | | | | | | |
|---|---|---|---|---|---|---|---|
| Attribute | Reference | ABCDE | AE | BE | CE | DE | BDE |
| Time to reach pH = 4.6 | 495 | 468 | 1102 | 434 | 853 | 1094 | 343 |
| (min) | | | | | | | |
| Brookfield (Pa * s) | 6.5 | 8.6 | 5.5 | 7.8 | 5.1 | 8.1 | 14 |
| Shear stress (Pa) | 20 | 23 | 16 | 24 | 15 | 18 | 39 |
| Gel strength | 71 | 74 | 76 | 84 | 80 | 75 | 111 |
| dynamic modulus G* | | | | | | | |
| (Pa) | | | | | | | |

The results show that all composition AE, BE, CE, DE, BDE and ABCDE improve the gel strength compared to the Reference composition.

### Example 3

### Effect of Lactic Acid Bacterial Strains on the Gel Strength of a Yogurt with Different Protein Contents

Yogurt was made according to recipe B, C and D as defined in Table 3 and according to the method described in the Materials and Methods.

TABLE 6

| | | | Time to | | | |
|---|---|---|---|---|---|---|
| | | | reach | Gel | Shear | |
| | | Protein | pH 4.6 | Strength | Stress | Brookfield |
| Composition | Recipe | (%) | (min) | (Pa) | (Pa) | (Pa * s) |
| ABCDE | B | 2.9 | 370 | 39 | 20 | 7.4 |
| ABCDE | C | 5.1 | 450 | 179 | 40 | 22.7 |
| ABCDE | D | 3.5 | 466 | 74 | 23 | 8.6 |
| BDE | D | 3.5 | 450 | 111 | 38 | 13.8 |
| Reference | D | 3.5 | 495 | 71 | 19.6 | 6.4 |

The results in table 6 clearly show that increasing the protein content of a yogurt (2.9-3.5-5.1%), increases the gel strength (39-74-179 Pa respectively), the shear stress (20-23-40 Pa respectively) as well as the Brookfield of the yogurt (7.4-8.6-22.7 Pa*s respectively).

The results in table 6 also show that ABCDE and BDE are increasing the gel strength, the shear stress as well as the Brookfield of the yogurt when compared with the Reference composition.

The results in in table 6 furthermore show that composition BDE, compared to ABCDE, even further increases the gel strength, the shear stress as well as the Brookfield of the yogurt with a protein content of 3.5% (recipe D).

In particular, composition BDE increases the gel strength of the yogurt with 3.5% protein made with ABCDE (74 Pa) to the gel strength of a yogurt with ˜4.5% protein (made with ABCDE), This can be deduced by interpolation of the data obtained with ABCDE as the 3 protein levels (not shown). Similarly, composition BDE increases the shear stress of the yogurt with 3.5% protein made with ABCDE (23 Pa) to the shear stress of a yogurt with ˜5.0% protein (made with ABCDE). Finally, composition BDE increases the Brookfield of the yogurt with 3.5% protein made with ABCDE (8.6 Pa*s) to the Brookfield of a yogurt with ˜5.0% protein.

### Example 4

### Effect of Lactic Acid Bacterial Strains on the Time to Reach pH 4.6, Shear Stress and Viscosity of a Yogurt with Different Protein Contents, in Comparison with Commercially Available Strains

Yogurt was made according to recipe E, F and G as defined in Table 3 and according to the method described in the Materials and Methods. Additionally starter culture TA40 and YO-MIX™ 883 were used to inoculate the recipe E, F and G. TA40 and YO-MIX™ 883 are both commercially available from Danisco A/S and comprise Streptococcus thermophilus and Lactobacillus delbrueckii strains. Both cultures are known for providing thickness, as is exemplified for TA40 for example in FIG. 1 of US2009/0226567.

TABLE 7

| | | | Time to | | |
|---|---|---|---|---|---|
| | | | reach | Shear | |
| | | Protein | pH 4.6 | Stress | Brookfield |
| Composition | Recipe | (%) | (min) | (Pa) | (Pa * s) |
| BD | E | 3.4 | 318 | 59 | 8.2 |
| BDE | E | 3.4 | 356 | 56 | 7.1 |
| TA40 | E | 3.4 | 467 | 44 | 5.4 |
| YO-MIX ™ 883 | E | 3.4 | n.a. | 44 | 5.6 |
| BD | F | 3.8 | 339 | 62 | 10.3 |
| BDE | F | 3.8 | 368 | 58 | 8.3 |
| TA40 | F | 3.8 | 443 | 50 | 6.8 |
| YO-MIX ™ 883 | F | 3.8 | 861 | 52 | 6.4 |
| BD | G | 4.2 | 366 | 68 | 12.1 |
| BDE | G | 4.2 | 412 | 66 | 10.9 |
| TA40 | G | 4.2 | 523 | 58 | 8.6 |
| YO-MIX ™ 883 | G | 4.2 | 838 | 58 | 8.7 |

The results in Table 7 clearly show that BD and BDE increase the shear stress as well as the Brookfield of the yogurt when compared with the TA40 and YO-MIX™ 883. Furthermore, Table 7 clearly shows that the time to reach pH 4.6 is lower for BD and BDE at all protein levels.

Similarly FIG. 1 shows the shear stress at 215 s-1 (PA) for compositions BD, BDE, TA40 and YO-MIX™ 883 for recipes E, F and G. FIG. 1 clearly shows a higher shear stress for compositions BD and BDE in comparison with TA40 and YO-MIX™ 883 for all three recipes E, F and G. Thus, BD and BDE increase the shear stress even in recipes with reduced amounts of protein, i.e. from 4.2 to 3.8 and 3.4% protein.

Moreover, BD is able to provide a shear stress/Brookfield in yogurt recipe E having 3.4% protein of 59 Pa, while TA40 and YO-MIX™ 883 provide a comparable shear stress of 58 in yogurt recipe G having 4.2% protein. Thus, by using BD the protein can be reduced with 0.8% of the yogurt while maintaining the shear stress. In other words, BD provides a reduction in protein level of 19%.

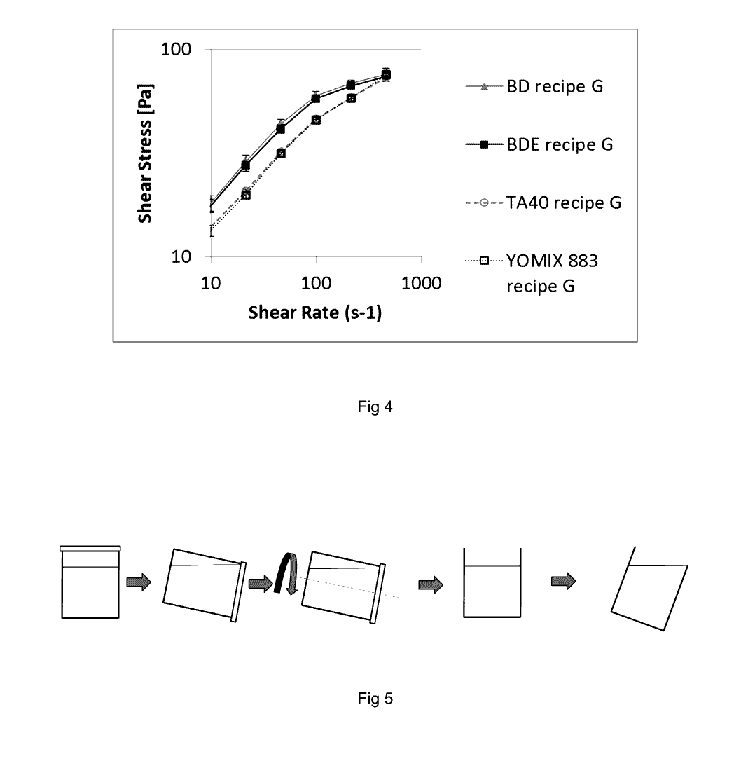

FIGS. 2 to 4 show the shear stress versus shear rate for compositions BD, BDE, TA40 and YO-MIX™ 883 for recipe E, F and G having 3.4, 3.8 and 4.2% protein, respectively. FIGS. 2 to 4 shows that the higher shear stress of composition BD and BDE when compared with TA40 and YO-MIX™ 883 is consistent over the shear rate of 10 to 300 s⁻¹, which is the relevant range for determination of shear stress in yogurts.

### Example 5

### Effect of Lactic Acid Bacterial Strains on Serum Viscosity of a Yogurt with Different Protein Contents, in Comparison with Commercially Available Strains

Similar to example 4, yogurt was prepared with recipes E, F and G with lactic acid bacteria BD, BDE, TA40 and YO-MIX™ 883. Table 8 below shows the results of the measured serum viscosity

TABLE 8

| | | Protein | Serum viscosity |
|---|---|---|---|
| Composition | Recipe | (%) | (mPa * s) |
| BD | E | 3.4 | 2.19 |
| BDE | E | 3.4 | 2.15 |
| TA40 | E | 3.4 | 1.90 |
| YO-MIX ™ 883 | E | 3.4 | 2.12 |
| BD | F | 3.8 | 2.37 |
| BDE | F | 3.8 | 2.38 |
| TA40 | F | 3.8 | 2.11 |
| YO-MIX ™ 883 | F | 3.8 | 2.35 |
| BD | G | 4.2 | 2.50 |
| BDE | G | 4.2 | 2.44 |
| TA40 | G | 4.2 | 2.21 |
| YO-MIX ™ 883 | G | 4.2 | 2.43 |

As can be seen in Table 8, the serum viscosity of BD and BDE is improved if compared with the serum viscosity of TA40 and YO-MIX™ 883 for recipe E, F and G having 3.4, 3.8 and 4.2% protein. In comparison with TA40, BD is nearly able to provide the TA40 serum viscosity of 2.21 in yogurt with 4.2% protein, however in a yogurt having only 3.4% protein. Thus BD is able to improve serum viscosity and reduce the protein content of yogurt.

### Example 6

### Effect of Lactic Acid Bacterial Strains in a Sensory Panel Test of a Yogurt with Different Protein Contents, in Comparison with Commercially Available Strains

Similar to example 4, yogurt was prepared with recipes E, F and G with lactic acid bacteria BD, BDE, TA40 and YO-MIX™ 883. To study the perceived gel strength and serum viscosity by a sensory panel, a panel test is carried out as described in the materials and methods. The attribute ropiness is linked with serum viscosity, and the attribute thickness of mouth feel is linked with gel strength.

TABLE 9

| | | | | Sum of ranks |
|---|---|---|---|---|
| | | Protein | Sum of ranks | ‘Thickness of mouth |
| Composition | Recipe | (%) | ‘ropiness’ | feel’ |
| BD | E | 3.4 | 59 | 65 |
| BDE | E | 3.4 | 63 | 62 |
| TA40 | E | 3.4 | 59 | 36 |
| YO-MIX ™ 883 | E | 3.4 | 40 | 57 |
| BD | F | 3.8 | 68 | 64 |
| BDE | F | 3.8 | 57 | 54 |
| TA40 | F | 3.8 | 55 | 57 |
| YO-MIX ™ 883 | F | 3.8 | 41 | 45 |
| BD | G | 4.2 | 58 | 63 |
| BDE | G | 4.2 | 72 | 48 |
| TA40 | G | 4.2 | 57 | 54 |
| YO-MIX ™ 883 | G | 4.2 | 34 | 55 |

In Table 9 the highest sum of ranks per yogurt recipe are written in bold. Table 9 clearly shows that BD and BDE have the highest sum of ranks and are thus perceived as providing the most ropiness or providing the most thickness in the mouth.

1. A process for production of a fermented milk product, optionally yogurt, comprising fermenting milk using a composition comprising one or more bacterial strains selected from the group consisting of Streptococcus thermophilus DS71579 (Strain A), Streptococcus thermophilus D571586 (Strain B), Streptococcus thermophilus DS71584 (Strain C), Streptococcus thermophilus DS71585 (Strain D) and wherein the gel strength and/or the serum viscosity of the fermented milk product obtained, optionally yogurt, has been improved compared to the gel strength of a fermented milk product that has not been produced using the composition comprising one or more bacterial strains selected from the group consisting of Streptococcus thermophilus DS71579 (Strain A), Streptococcus thermophilus DS71586 (Strain B), Streptococcus thermophilus DS71584 (Strain C), Streptococcus thermophilus DS71585 (Strain D).

2. A process according to claim 1 wherein the composition is comprising Streptococcus thermophilus DS71586 (strain A).

3. A process according to claim 1 wherein the composition is comprising Streptococcus thermophilus DS71585 (strain B).

4. A process according to claim 1, wherein the composition is comprising Streptococcus thermophilus DS71586 (strain C).

5. A process according to claim 1, wherein the composition is comprising Streptococcus thermophilus DS71585 (strain D).

6. A process according to claim 1, wherein the composition further comprises one or more lactic acid bacteria selected from the group consisting of Streptococcus thermophilus and Lactobacillus delbrueckii ssp. Bulgaricus.

7. A process according to claim 1, wherein the composition further comprises a Lactobacillus delbrueckii ssp. bulgaricus strain.

8. A process according to claim 7, wherein the Lactobacillus delbrueckii ssp. Bulgaricus strain is Lactobacillus delbrueckii ssp. bulgaricus DS71836 (strain E).

9. A process claim 7, wherein the composition comprises Streptococcus thermophilus DS71579 (strain A) and Streptococcus thermophilus DS71586 (strain B) and Streptococcus thermophilus DS71584 (strain C) and Streptococcus thermophilus DS71585 (strain D) and Lactobacillus delbrueckii ssp. bulgaricus DS71836 (strain E).

10. A process according to claim 1, wherein the composition comprises Streptococcus thermophilus DS71586 (strain B) and Streptococcus thermophilus DS71585 (strain D) and preferably optionally Lactobacillus delbrueckii ssp. bulgaricus DS71836 (strain E).

11. A process according to claim 7 wherein the gel strength is improved.

12. A process according to claim 7 wherein the serum viscosity is improved.

13. A process according to claim 7 wherein the gel strength and the serum viscosity is improved.

14. A fermented milk product, optionally yogurt, obtainable by the process of claim 1, wherein the fermented milk product, optionally yogurt, has an improved gel strength and/or an improved serum viscosity compared to a fermented milk product, optionally yogurt, that has not been produced by said process.

15. A composition comprising one or more bacterial strains selected from the group consisting of Streptococcus thermophilus DS71579 (Strain A), Streptococcus thermophilus DS71586 (Strain B), Streptococcus thermophilus DS71584 (Strain C), Streptococcus thermophilus DS71585 (Strain D) for the production of the fermented milk product, optionally yogurt as defined in claim 14, having an improved gel strength and/or an improved serum viscosity compared to a fermented milk product, optionally yogurt, that has not been produced by said composition.

16. A composition for production of a fermented milk product, optionally yogurt, said composition comprising one or more bacterial strains selected from the group consisting of Streptococcus thermophilus DS71579 (Strain A), Streptococcus thermophilus DS71586 (Strain B), Streptococcus thermophilus DS71584 (Strain C), Streptococcus thermophilus DS71585 (Strain D), wherein the time to reach pH 4.6 is reduced compared to a fermented milk product, yogurt, that has not been produced by said composition.
